(19) United States
(12) Patent Application Publication
(10) Pub. No.: US 2015/0082703 A1
(43) Pub. Date: Mar. 26, 2015

(54) REMOTE CONTROL MECHANISM FOR SLIDING DOOR

(71) Applicant: Kia Motors Corp., Seoul (KR)

(72) Inventor: Do Won Kim, Seoul (KR)

(73) Assignee: Kia Motors Corp., Seoul (KR)

(21) Appl. No.: 14/080,410

(22) Filed: Nov. 14, 2013

(30) Foreign Application Priority Data
Sep. 23, 2013 (KR) 10-2013-0112783

(51) Int. Cl. E05B 53/00; E05B 85/10; E05F 11/54

(52) U.S. Cl. CPC E05B 53/00; E05F 11/54; E05B 85/10
USPC 49/279

(57) ABSTRACT

A remote control mechanism for a sliding door may include a handle lever installed to rotate about a rotational shaft in a base, connected to a first lever link connected to a door handle, and configured to be rotated by operation of the door handle, a hold lever installed to rotate about the rotational shaft in the base together with the handle lever, connected to a second lever link connected to the door handle, connected to a hold cable of a hold device, and configured to be rotated by operation of the door handle in order to control locking and releasing of the hold device, and an elastic member mounted to the rotational shaft, wherein the elastic member is fixed to the base and connected to the handle lever and the hold lever.

### CROSS-REFERENCE TO RELATED APPLICATION

The present application claims priority to Korean Patent Application No. 10-2013-0112783 filed Sep. 23, 2013, the entire contents of which is incorporated herein for all purposes by this reference.

### BACKGROUND OF THE INVENTION

1. Field of the Invention

The present invention relates to a remote control mechanism for a sliding door which returns a plurality of levers used to open and close the sliding door to original positions using one elastic member and makes operation of a handle smooth when a user opens or closes the sliding door.

2. Description of Related Art

Generally a vehicle is equipped with a sliding door which prevents dust or rain water from intruding into the inside of the vehicle, prevents safety accidents during driving, and is arbitrarily opened and closed to allow a passenger to get in or out of the vehicle.

Vehicles have different types of doors. For example, a large vehicle having a wide passenger door such as a full-size van and a minibus is equipped with a sliding door. In addition to the full-size van, other vehicles such as a small-size van, a recreational vehicle (RV), etc. are also mounted with a sliding door.

Typically the sliding door is provided with an inner handle installed inside the vehicle and an outer handle installed outside the vehicle. When the inner handle or outer handle is operated, a door latch operates so that locking of a striker in the sliding door is released. That is, when the inner handle or outer handle is operated, a state in which the door striker is locked in a door latch is released and the sliding door is enabled to be opened and closed. When the sliding door is closed, the striker is latched and locked by the door latch so that the locked state of the door is maintained.

The sliding door is equipped with a hold device which maintains the open state. The open state of the door is maintained by a mechanism similar to that of the latch device.

A remote control mechanism is provided for an opening/closing device for a sliding door and establishes interlocking among the latch device, the hold device, and the inner and outer handles.

The remote control mechanism includes a plurality of levers and a link structure which are mounted to open and close the sliding door. The plurality of levers is connected to and interlocks with the inner and outer handles, latch device, and hold device. Extension springs are used to return the inner and outer handles after the inner and outer handles are operated.

Each lever is equipped with an extension spring which provides restoration force. Since each lever is equipped with the extension spring, many extension springs are used. This results in a complicated structure and increases in the number of parts and manufacturing cost.

Each lever performs rotational motion when the inner or outer handle is operated. The extension spring suitable to linear motion is non-linearly extended during the rotational motion of the lever. This impairs performance of operation of the inner or outer handle and deteriorates durability of the extension spring.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a remote control mechanism for a sliding door which returns a plurality of levers, used to open and close the sliding door and rotated by a door handle, to original positions using one elastic member and makes the feeling for operation of the door handle smooth when a user operates the door handle to open or close the sliding door.

In order to achieve the above object, according to one aspect of the present invention, there is provided a remote control mechanism for a sliding door, including a handle lever which is installed to rotate about a rotational shaft in a base, connected to a first lever link connected to a door handle, and is rotated along with operation of the door handle, a hold lever which is installed to rotate about the rotational shaft in the base together with the handle lever, connected to a second link connected to the door handle, connected to a hold cable of a hold device, and rotated along with the operation of the door handle so that locking and releasing of the hold device is controlled, and an elastic member which is installed to rotate about the rotational shaft in the base and connected to the handle lever and hold lever in order to provide restoration force exerting in a direction opposite to rotational directions of the handle lever and hold lever when the handle lever and hold lever are rotated.

The remote control mechanism for a sliding door may further include a latch lever which is installed to rotate about the rotational shaft in the base together with the handle lever, connected to a latch cable of a latch device, and is rotated along with operation of the handle lever.

A first end of the handle lever may be connected to the first lever link and a second end of the handle lever may be connected to the latch lever. When the door handle is operated to open the sliding door, the first lever link is pulled and the handle lever is rotated. As a result, the latch lever is operated, the latch cable is pulled, and locking of the latch device is released.

A first end of the hold lever may be connected to the hold cable of the hold device and a second end of the hold lever may be connected to the second lever link. When the door handle is operated to close the sliding door, the hold lever is rotated as the second lever link is pushed and the hold cable connected to the first end of the hold lever is pulled. As a result, the locking of the hold device is released.

The elastic member may be a torsion spring which is installed to wind around the rotational shaft, connected to the base, and connected to the handle lever and hold lever in order to provide elastic force.

The elastic member may include a body part installed to wind around the rotational shaft in the base in order to provide elastic force, a first string extending from the body part and being connected and fixed to the base, a second string extending from the body part and being connected to the handle lever in order to provide force of restoration when the handle lever is rotated, and a third string extending from the body part and being connected to the hold lever in order to provide restoration force when the hold lever is rotated.

In the elastic member, the first string may provide supporting force in a rotational direction of the handle lever and hold lever, and the second and third strings may provide elastic force in a direction opposite to the rotational direction of the handle lever and hold lever.

In the elastic member, respective ends of the first, second, and third strings are bent to have a hook shape and the first, second, and third strings are hooked into the base, handle lever, and hold lever, respectively.

The base may be provided with a mounting portion into which the first string of the elastic member is hooked.

The second string of the elastic member may extend to be hooked into a side edge of the handle lever and a leading end of the handle lever in the rotational direction of the handle lever.

The third string of the elastic member may extend to be hooked into a side edge of the handle lever and a leading end of the handle lever in the rotational direction of the handle lever.

According to another aspect of the present invention, there is provided a remote control mechanism for a sliding door, including a handle lever which is installed to rotate about a rotational shaft in a base and connected to a first lever link having an end connected to a door handle, a hold lever which is installed to rotate about the rotational shaft in the base together with the handle lever, connected to a second lever link connected to the door handle, connected to a hold cable of a hold device, and rotated by operation of the door handle in order to control locking and releasing of the hold device, a latch lever which is installed to rotate about the rotational shaft in the base together with the handle lever, connected to a latch cable of a latch device, and is rotated by the operation of the handle lever, and a torsion spring which is installed to wind around the rotational shaft in the base and which includes a first string connected to and supported by the base, a second string connected to the handle lever in order to provide restoration force to the handle lever, and a third string connected to the hold lever in order to provide force of restoration to the hold lever.

According to this structure, the restoration force for returning multiple levers to original positions are provided by one elastic member, resulting in an improvement in smoothness of operation of the door handle, and decreases in the operational force, manufacturing cost, and the number of parts used.

In comparison with a conventional art which uses multiple existing extension springs to return rotated levers to original positions, thus making a user feel heavy tension when operating a door handle, the remote control mechanism for a sliding door according to the present invention uses one torsion spring to provide the restoration force for returning multiple levers to original positions. That is, since the torsion spring suitably used for rotational motion is adopted, a user may feel a light and smooth operation of the door handle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating operation of a remote control mechanism for a sliding door according to one embodiment of the present invention.

FIG. 2 is a diagram illustrating a door handle which switches to an open state from a closed state through the operation of the remote control mechanism illustrated in FIG. 1.

FIG. 3 is a diagram illustrating the door handle which switches to a closed state from an open state through the operation of the remote control mechanism illustrated in FIG. 1.

FIG. 4 is a diagram illustrating connection between each lever and an elastic member of the remote control mechanism for a sliding door.

FIG. 5 is a diagram illustrating the elastic member of the remote control mechanism for a sliding door.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinbelow, preferred embodiments of the present invention will be described in detail with reference to the accompanying drawings.

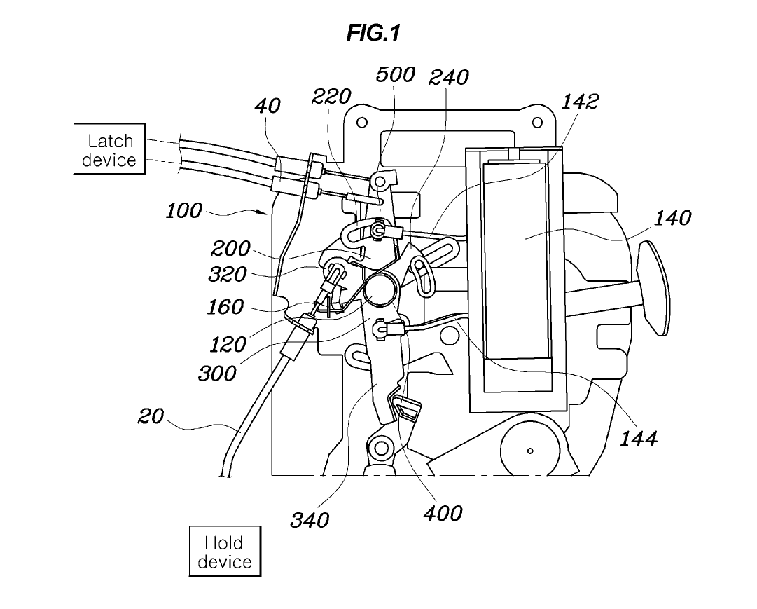

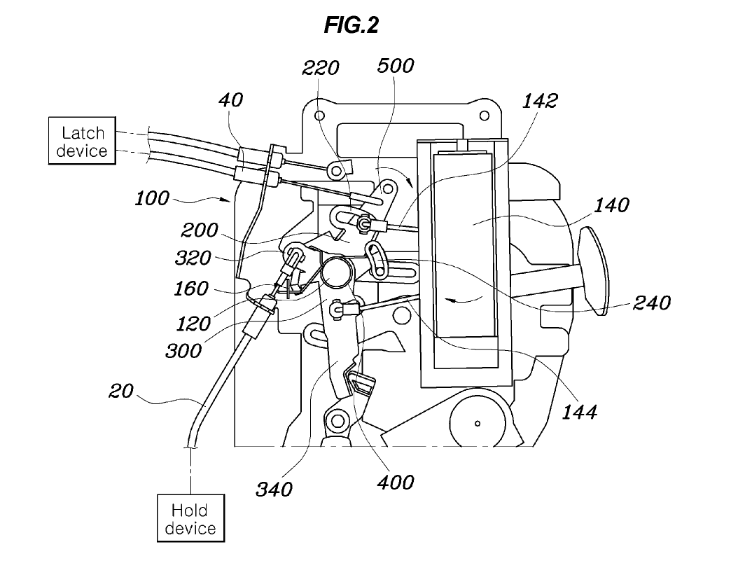

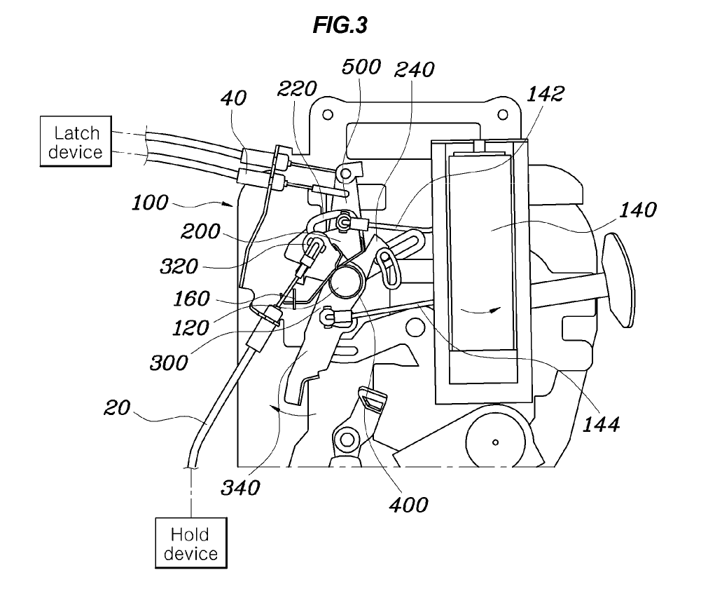

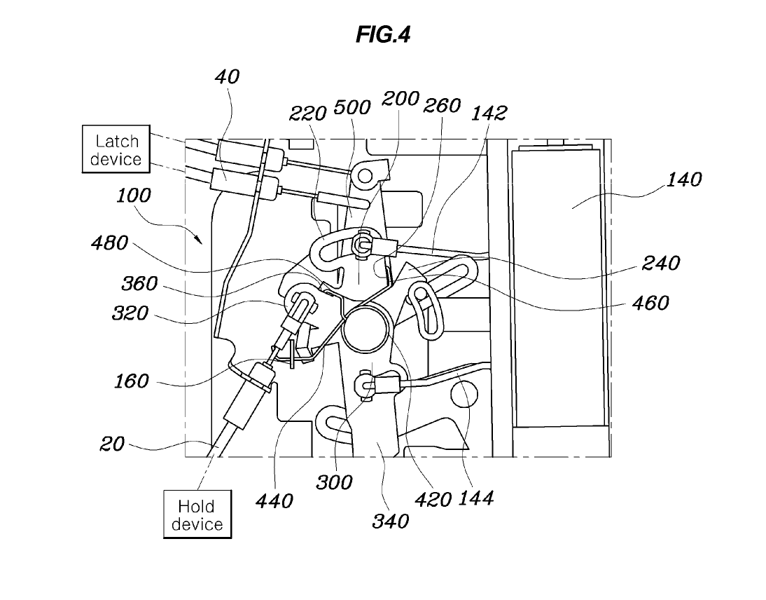

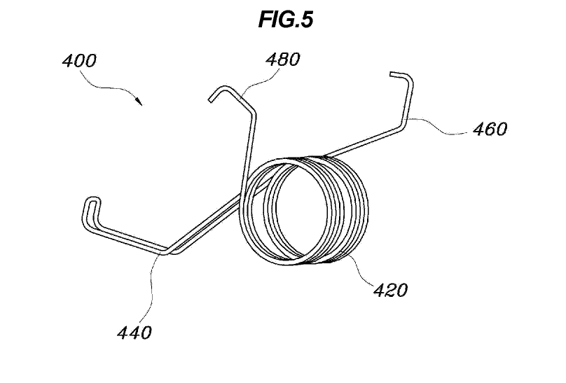

FIG. 1 is a diagram illustrating operation of a remote control mechanism for a sliding door according to one embodiment of the present invention, FIG. 2 is a diagram illustrating a door handle which switches to an open state from a closed state through the operation of the remote control mechanism illustrated in FIG. 1, FIG. 3 is a diagram illustrating the door handle which switches to a closed state from an open state through the operation of the remote control mechanism illustrated in FIG. 1, FIG. 4 is a diagram illustrating connection between each lever and an elastic member of the remote control mechanism for a sliding door, and FIG. 5 is a diagram illustrating the elastic member of the remote control mechanism for a sliding door.

Generally an inner handle and an outer handle are installed in an inner surface and an outer surface of a sliding door, respectively in order to open and close the sliding door. The inner and outer handles are connected to a latch device, so that the sliding door is opened or closed when the inner or outer handle is operated. A vehicle is equipped with a hold device which maintains an open state of the sliding door. The hold device is linked to the inner and outer handles so that the hold device interlocks with the handles. That is, the hold device locks or releases a certain state of the sliding door, interlocking with the handles.

The latch device and hold device are mechanisms which are conventionally used for most of the vehicles. Accordingly, a description thereabout is omitted.

The inner handle and outer handle are collectively called a door handle 140 in this specification. The inner handle and outer handle are differently designed considering installation positions and may be adopted by the present invention.

In a remote control mechanism which relays operation of the door handle 140 to the latch device and hold device through a plurality of levers, all levers are installed to rotate about a rotational shaft 120 and restoration force is provided by one elastic member 400. This improves smoothness in operation of the door lever and reduces manufacturing cost.

The remote control mechanism for a sliding door according to an exemplary embodiment of the present invention includes a handle lever 200, a hold lever 300, and an elastic member 400. The handle lever 200 is installed in a base 100 in a manner of rotating about the rotational shaft 120, connected to a first lever link 142 connected to the door handle, and is rotated by operation of the door handle 140. The hold lever 300 is installed to rotate about the rotational shaft 120 of the base 100 together with the handle lever 140, connected to a second lever link 144 connected to the door handle 140, and connected to a hold cable 20 of a hold device. The hold lever 300 is rotated by operation of the door handle 140, locking or releasing the hold device. The elastic member 400 is installed to wind around the rotational shaft 120 of the base 100, and connected to the handle lever 200 and hold lever 300. The elastic member 400 provides restoration force in a direction opposite to rotational directions of the handle lever 200 and the hold lever 300 when the handle lever 200 and hold lever 300 rotate.

The rotational directions of the handle lever 200 and hold lever 300 are called operational directions of the handle lever 200 or hold lever 300 when the door handle 140 is operated and the handle lever 200 or hold lever 300 is pulled via the first lever link 142 or second lever link 144. Specifically, as for the handle lever 200, when the door handle 140 is operated to switch the sliding door from a closed state to an open state, the handle lever 200 is pulled via the first lever link 142 connected to the handle lever 200 so that the handle lever 200 is rotated. As for the hold lever 300, when the door handle 140 is operated to switch the sliding door from the open state to the closed state, the hold lever 300 is pulled via the second lever link 144 connected to the hold lever 300 so that the hold lever 300 is rotated.

As illustrated in FIG. 1, the rotational shaft 120 is installed in the base 100, and the handle lever 200 and the hold lever 300 are installed in a manner of rotating about the rotational shaft 120. The handle lever 200 is installed to rotate about the rotational shaft 120 and is connected to the first lever link 140 which transfers operational force of the door handle 140, so that the handle lever 200 is rotated along with the operation of the door handle 140. That is, when the door handle 140 is operated in the direction to open the sliding door, the first lever link 142 is pulled and thus the handle lever 200 connected to the first lever link 142 is also pulled, so that the handle lever 200 is rotated.

The latch lever 500 is installed to rotate about the rotational shaft 120 of the base 100 together with the handle lever 200 and connected to a latch cable 40 of a latch device. The latch lever 500 is rotated along with the operation of the handle lever 200.

A first end 220 of the handle lever 200 is connected to the first lever link 142, and a second end 240 of the handle lever 200 is connected to the latch lever 500. When the door handle 140 is operated in the direction to open the sliding door, the first lever link 142 is pulled and the handle lever 200 is rotated. At this time, the latch lever 500 is also rotated because the latch lever 500 is interlocked with the handle lever 200, and the latch cable 40 is pulled. This operation releases locking of the latch device. Since the locking of the latch is released through these operations, the sliding door is allowed to open.

The hold lever 300 is installed to rotate about the rotational shaft 120 in the base 100 together with the handle lever 200 and the latch lever 500, and is connected to the second lever link 144 which transfers the operational force of the door handle 140, so that the hold lever 300 is rotated along with the operation of the door handle 140. That is, when the door handle 140 is operated to close the sliding door, the second lever link 144 is pushed, pushing the hold lever 300. At this time, the hold lever 300 is rotated.

A first end 320 of the hold lever 300 is connected to the hold cable 20 of the hold device and a second end 340 of the hold lever 300 is connected to the second lever link 144. When the door handle 140 is operated to close the sliding door, the second lever link 144 is pushed and the hold lever 300 is rotated. At this time, the hold cable 20 connected to the first end 320 of the hold lever 300 is pulled, releasing the locking of the hold device.

Through these operations, the locking of the hold device is released in a state where the sliding door is opened. As a result, the sliding door enters a state where the sliding door can be closed.

Each of the handle lever 200, hold lever 300, and latch lever 500 which are rotated when the door handle 140 is operated to open or close the sliding door is provided with the elastic member 400 which returns the levers to their original positions when the operational force of the door handle 140 is removed, so that the door handle 140 can be repeatedly operated.

As the elastic member 140, conventional levers use corresponding extension springs. Accordingly a large number of springs are used, increasing the cost. Furthermore, although the extension springs are suitable to linear motion, the levers perform rotational motion. Accordingly, the extension springs have to perform both of rotational motion and linear motion. This makes a user feel that levers do not smoothly operate.

In order to solve the problem of the conventional art, according to an exemplary embodiment of the present invention, all of the levers, including the handle lever 200 and hold lever 300, are rotated about the rotational shaft 120 installed in the base 100.

The elastic member 400 for imparting the levers with restoration force is configured using a torsion spring which is installed to wind around the rotational shaft 120, connected to the base 100 such as to be rotatably supported, and connected to the handle lever 200 and hold lever 300. That is, one spring imparts each lever with restoration force. Accordingly, it is not necessary to use a plurality of springs, and as a result, manufacturing cost is reduced.

Furthermore, since the torsion spring is suitably used for rotational motion, each lever gains sufficient restoration force while it performs the rotational motion. Accordingly, the operational force is reduced compared with the use of the extension spring, and thus a user can feel smoother operation of the levers.

The elastic member 400 is more specifically described below. As illustrated in FIGS. 4 and 5, the elastic member 400 includes a body part 420 which is installed in a manner of winding around the rotational shaft 120 of the base 100 to give elastic force, a first string 440 extending from the body part 420 and being fixed and connected to the base 100, a second string 460 extending from the body part 420 and being connected to the handle lever 200 in order to provide restoration force to return the handle lever 200 to the original position of the handle lever 200 after the handle lever 200 is rotated, and a third string 480 extending from the body part 420 and being connected to the hold lever 300 in order to provide restoration force to the hold lever 300.

The body part 420 of the elastic member 400 imparts each string with elastic force. The plurality of strings rotates about the body part 320 and is imparted with the elastic force. The handle lever 200 and hold lever 300 are installed to be supported by a hinge shaft of the base 100 so that they rotate about the hinge shaft. Since the body part 420 of the elastic member 400 is installed to be supported by the hinge shaft, the center of rotation of the elastic member 400 is in agreement with the center of rotation of the handle lever 200 and hold lever 300. Accordingly, rotation of each lever and each string is smoothly carried out.

The first string 440 of the elastic member 400 is connected and fixed to the base 100. This is to provide restoration force to the second string 460 and third string 480 so that the second string 460 and third string 480 are returned to the original positions after the second string 460 and third string 480 are rotated along with rotation of the handle lever 200 and hold lever 300. The second string 460 is connected to the handle lever 200 in order to provide restoration force to the handle lever 2000, and the third string 480 is connected to the hold lever 300 in order to provide restoration force to the hold lever 300.

As described above, the first string 440 of the elastic member 400 provides the supporting force in the rotational direction to the handle lever 200 and hold lever 300, and the second string 460 of the elastic member 400 provides the elastic force in a direction opposite to the operational direction to the handle lever 200 and hold lever 300.

That is, when the door handle 140 is operated, the handle lever 200 and hold lever 300 are rotated, and the second string 460 and third string 480 which extend from the body part 420 of the elastic member 400 are rotated in the same direction as the rotational direction of each lever. Because the first string 440 is coupled to the base 100, the body part 420 will not be rotated. When operation of the door handle 140 is completed, the second string 460 and third string 480 are returned to the original positions and each lever is also returned to its original position.

Respective ends of the first string 440, second string 460, and third string 480 of the elastic member 400 are bent to have a hook shape. The end portions of the strings are hooked into the base 100, handle lever 200, and hold lever 300, respectively.

Since the respective end portions of the strings of the elastic member 400 are formed to have a hook shape and hooked into the base and the levers, an operator can easily connect the elastic member 400 to the base 100 and the levers. Accordingly, assembling time for the remote control mechanism for the sliding door is reduced, resulting in an improvement in productivity and a decrease in worker's laboring load.

Here, the first string 440 of the elastic member 400 may be formed to be bent in a direction in which the handle lever 200 and hold lever 300 are operated. The first string 440 serves to prevent the body part 420 of the elastic member 400 from being rotated along with the rotation of the second string 460 and third string 480 when the handle lever 200 and hold lever 300 are rotated and when the second string 460 and third string 480 are also rotated. That is, since the first string 440 has to have a reaction force against the rotation of each lever, the first string 440 is bent in the operational direction of the handle lever 200 and hold lever 300 and coupled to the base 100. Accordingly, even though the second string 460 and third string 480 are rotated, rotation of the first string 440 is prevented because the end portion of the first string 440 is fixed to the base 100. The base 100 has a mounting portion 160 into which the end portion of the first string 440 of the elastic member 400 is hooked. In this way, the elastic member 400 is mounted and fixed to the base 100.

On the other hand, the second string 460 of the elastic member 400 is hooked into a side edge portion of the handle lever 200 and a leading end 260 of the handle lever 200 in the rotational direction.

The third string 480 of the elastic member 400 is hooked into a side edge portion of the hold lever 300 and a leading end of the hold lever 300 in the rotational direction.

The second string 460 and third string 480 of the elastic member 400 provide restoration force to the handle lever 200 and hold lever 300, respectively so that the handle lever 200 and hold lever 300 can be returned to their original positions after the handle lever 200 and hold lever 300 are rotated. In order to return the second string 460 and third string 480 to the original positions at which the second string 460 and third string 480 are positioned before the rotations, the elastic restoring force has to be exerted in the direction opposite to the rotational direction of each lever.

To this end, as illustrated in FIG. 3, the second string 460 and third string 480 of the elastic member 400 are hooked into the leading ends of the handle lever 200 and hold lever 300 in the rotational direction. In this way, the elastic member 400 can provide the elastic restoring force exerting in the direction opposite to the rotational direction to each lever.

The operation of the present invention will be described below in detail. As illustrated in FIG. 1, the door handle 140 is operated to open the sliding door from a closed state in which the sliding door is closed, the first lever link 142 is pulled and the handle lever 200 is rotated. As the handle lever 200 is rotated, the latch lever 500 interlocking with the handle lever 200 is also rotated and the latch cable is pulled. As the latch cable is pulled, locking of the latch device is released. At this time, the second string 460 of the elastic member 400 provides the handle lever 200 with reaction force exerting against the rotation of the handle lever 200. This makes a user feel the operational force of the door handle 140. Furthermore, since the elastic member 400 is engaged with the hinge shaft and thus is not displaced when the handle lever 200 is rotated, the reaction force against the rotation of the handle lever 200 is exerted on the handle lever 200. Accordingly, the operational force is reduced as compared with the use of a conventional extension spring, so that the user can feel smooth operation of the door handle 140.

When force of operating the door handle 140 is removed, the second string 460 of the elastic member 400 returns the handle lever 200 to the original position, and then the handle lever 200 can be ready for the following operation. That is, the door handle 140 can be repeatedly operated.

When the door handle 140 is operated to close the sliding door from the open state in which the sliding door opens, the second lever link 144 is pushed by the rotation of the door handle 140, causing the rotation of the hold lever 300. As the hold lever 300 is rotated, the hold cable is pulled and the locking of the hold device is released. At this time, the third string 480 of the elastic member 400 provides a reaction force against the rotation of the handle lever 200, and the user will feel the operational force of the door handle 140.

When force of operating the door handle 140 is removed, the third string 480 of the elastic member 400 functions to return the handle lever 200 to the original position.

The remote control mechanism for the sliding door which has the above described structure returns a plurality of levers which are used to open and close the sliding door and rotated by the door handle 140 to the original positions using one elastic member. Accordingly, it is possible to reduce the number of parts used and manufacturing cost of a vehicle.

In comparison with a conventional art which uses multiple existing extension springs to return rotated levers to original positions and thus which makes a user feel heavy tension when operating a door handle, the remote control mechanism for a sliding door according to an exemplary embodiment of the present invention uses one torsion spring to provide restoration force for returning multiple levers to original positions. That is, since the torsion spring which is suitably used for rotational motion is adopted, a user may feel light and smooth operation of the door handle 140.

In conclusion, the remote control mechanism for a sliding door may include the handle lever 200, the hold lever 300, the latch lever 500, and the torsion spring. The handle lever 200 is installed in a manner of rotating about the rotational shaft 120 of the base 100 and connected to the first lever link 142 which is connected to the door handle 140, so that the handle lever 200 may be rotated by the operation of the door handle 140. The hold lever 300 is installed in a manner of rotating about the rotational shaft 120 of the base 100 together with the handle lever 200 and connected to the second lever link 144 which is connected to the door handle 140 and to the hold cable of the hold device, so that the hold lever 300 may be rotated by the operation of the door handle 140, thereby releasing the locking of the hold device. The latch lever 500 is installed in a manner of rotating about the rotational shaft 120 of the base together with the handle lever 200 and connected to the latch cable of the latch device, so that the latch lever 500 is rotated by the rotation of the handle lever 200. The torsion spring 480 includes the first string 440 mounted to the rotational shaft 120 of the base 100 and connected to the base 100, the second string 460 connected to the handle lever 200 in order to provide restoration force to the handle lever 200, and the third string 480 connected to the hold lever 300 in order to provide restoration force to the hold lever 300.

According to this structure, the restoration force for returning multiple levers to original positions is provided by one elastic member, resulting in an improvement in smoothness of operation of the door handle, and decreases the operational force, manufacturing cost, and the number of parts used.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A remote control mechanism for a sliding door, comprising:
a handle lever installed to rotate about a rotational shaft in a base, connected to a first lever link connected to a door handle, and configured to be rotated by operation of the door handle;
a hold lever installed to rotate about the rotational shaft in the base together with the handle lever, connected to a second lever link connected to the door handle, connected to a hold cable of a hold device, and configured to be rotated by operation of the door handle in order to control locking and releasing of the hold device; and
an elastic member mounted to the rotational shaft, wherein the elastic member is fixed to the base and connected to the handle lever and the hold lever in order to provide restoration force in a direction opposite to a direction of rotation of the handle lever and the hold lever when the handle lever and the hold lever are rotated.

2. The remote control mechanism for the sliding door according to claim 1, further comprising:
a latch lever installed to rotate about the rotational shaft in the base together with the handle lever, connected to a latch cable of a latch device, and configured to be rotated along with rotation of the handle lever.

3. The remote control mechanism for the sliding door according to claim 2,
wherein a first end of the handle lever is connected to the first lever link and a second end of the handle lever is connected to the latch lever, and
wherein the first lever link is pulled and the handle lever is rotated when the door handle is operated to open the sliding door, and then the latch lever is rotated along with the rotation of the handle lever, the latch cable is pulled, and locking of the latch device is released.

4. The remote control mechanism for the sliding door according to claim 1,
wherein a first end of the hold lever is connected to the hold cable of the hold device and a second end of the hold lever is connected to the second lever link, and
wherein the second lever link is pushed and the hold lever is rotated when the door handle is operated to close the sliding door, and then the hold cable connected to the first end is pulled and locking of the hold device is released.

5. The remote control mechanism for the sliding door according to claim 1, wherein the elastic member is a torsion spring which is mounted to the rotational shaft, connected to the base and connected both to the handle lever and to the hold lever in order to provide elastic force.

6. The remote control mechanism for the sliding door according to claim 1, wherein the elastic member comprises:
a body part mounted to the rotational shaft in the base in a manner of winding around the rotational shaft;
a first string extending from the body part and being fixed to the base;
a second string extending from the body part and being connected to the handle lever in order to provide restoration force; and
a third string extending from the body part and being connected to the hold lever in order to provide restoration force.

7. The remote control mechanism for the sliding door according to claim 6, wherein the first string provides supporting force in rotational directions of the handle lever and the hold lever, and the second and third strings provide elastic force in a direction opposite to the rotational directions of the handle lever and the hold lever.

8. The remote control mechanism for the sliding door according to claim 6, wherein respective ends of the first, second, and third strings of the elastic member are bent to have a hook shape, and the respective ends are hooked into the base, the handle lever, and the hold lever, respectively.

9. The remote control mechanism for the sliding door according to claim 6, wherein the base is provided with a mounting portion into which the first string is hooked.

10. The remote control mechanism for the sliding door according to claim 6, wherein the second string of the elastic member is hooked into a side edge of the handle lever and a leading end of the handle lever in the rotational direction of the handle lever.

11. The remote control mechanism for the sliding door according to claim 6, wherein the third string of the elastic member is hooked into a side edge of the hold lever and a leading end of the hold lever in the rotational direction of the hold lever.

12. A remote control mechanism for a sliding door, comprising:
a handle lever installed to rotate about a rotational shaft in a base, connected to a first lever link connected to a door handle, and configured to be rotated by operation of the door handle;
a hold lever installed to rotate about the rotational shaft in the base together with the handle lever, connected to a second lever link connected to the door handle, connected to a hold cable of a hold device, and configured to be rotated by operation of the door handle thus to control locking and releasing of the hold device;
a latch lever installed to rotate about the rotational shaft in the base together with the handle lever, connected to a latch cable of a latch device, and configured to be rotated along with the rotation of the handle lever; and
a torsion spring which is mounted to the rotational shaft in the base and includes a first string connected to and supported by the base, a second string connected to the handle lever to provide force of restoration to the handle lever, and a third string connected to the hold lever to provide restoration force to the hold lever.
